(19) United States
(12) Patent Application Publication
(10) Pub. No.: US 2023/0042589 A1
(43) Pub. Date: Feb. 9, 2023

(54) METHODS AND SYSTEMS FOR SELLING AND BUYING MASS CUSTOMIZATION PRODUCTS

(71) Applicant: Global Graphics Software Limited, Cambridge (GB)

(72) Inventor: Eric Worrall, Cambridgeshire (GB)

(21) Appl. No.: 17/392,633

(22) Filed: Aug. 3, 2021

(51) Int. Cl. G06Q 30/06; G06K 7/10; G06Q 20/20; G06K 9/00

(52) U.S. Cl. CPC G06Q 30/0621; G06Q 30/0623; G06K 7/10861; G06Q 20/208; G06Q 20/203; G06K 9/00711; G06K 2007/10504

(57) ABSTRACT

A method for identifying an object or product for purchase includes scanning, by the user, an example object for a code or marking; reading the code or marking; communicating with a database to index the code or marking with information about the example object, wherein the information includes contact information or a contact link for a manufacturer or supplier of the example object; and receiving the information and providing the information to the user. A method for purchasing a product based on the information can include receiving an order for a product using the contact information or contact link for the manufacturer or supplier; receiving payment for the order; and delivering a portion of the payment to an entity that displayed the example object from which the code or marking was scanned.

### FIELD

The present invention is directed to the area of displaying objects and facilitating sales of the objects. The present invention is also directed to methods and systems for displaying objects and facilitating sales of the personalized variations of those objects.

### BACKGROUND

Consumers are buying more products online and purchasing from physical stores less. Consumers can be inspired to buy products from their experiences in the real world. For example, when staying at a boutique hotel, a consumer is surrounded by curated items (for example, lamps, wallpaper, flooring, ceramics, tiles, carpets, drapes, decorative objects, or the like). However, it may be challenging to recreate the look of a boutique hotel. For example, a lamp may be displayed in the hotel and a consumer may be interested in obtaining a similar lamp. The consumer could look for a label, but the label may have been removed. The consumer might ask the staff, but the staff likely would not know where the lamp was purchased. Accordingly, it would be useful to have a mechanism for identifying and facilitating sales of the objects.

In addition, products are moving increasingly to mass customization (personalized for many different consumers) and away from mass production (many of the same products). If mass customization becomes widespread, then physical stores cannot display for the consumer all of the different variations of goods to buy. Moreover, the physical store cannot sell the consumer these personalized goods because the goods are made to order for the individual consumer so the store cannot stock them. However, if every product is different (e.g., personalized), how does the consumer discover what the consumer would like to purchase.

### BRIEF SUMMARY

One embodiment is a method for identifying an object or product for purchase. The method includes scanning, by the user, an example object for a code or marking; reading the code or marking; communicating with a database to index the code or marking with information about the example object, wherein the information includes contact information or a contact link for a manufacturer or supplier of the example object; and receiving the information and providing the information to the user.

In at least some embodiments, the method further includes sending an order for a product using the contact information or contact link for the manufacturer or supplier. In at least some embodiments, the information includes at least one alterable feature to alter the example object to become a product for purchase by the user.

In at least some embodiments, the method further includes providing, for user selection, at least one alterable feature to alter the example object for a product for purchase by the user. In at least some embodiments, the at least one alterable feature includes at least one of color, decoration, pattern, size, material, shape, or type of product.

In at least some embodiments, the scanning includes scanning the example object in situ. In at least some embodiments, the scanning includes scanning the example object displayed in a video presentation. In at least some embodiments, the code or marking is not visible to the user. In at least some embodiments, the code or marking is incorporated in a decoration or pattern presented on the example object. In at least some embodiments, the code or marking is incorporated on a label attached to, or near, the example object.

Another embodiment is a method for purchasing a product. The method includes providing a database of codes or markings that are scanned from example objects, wherein the database includes information about the example objects including, for each example object, a manufacturer or supplier of the example object and either contact information or a contact link for the manufacturer or supplier; receiving, from requester, a communication to index a code or marking; providing the information to the requester; receiving an order for a product using the contact information or contact link for the manufacturer or supplier; receiving payment for the order; and delivering a portion of the payment to an entity that displayed the example object from which the code or marking was scanned.

In at least some embodiments, the information includes at least one alterable feature to alter the example object for a product for purchase by the user. In at least some embodiments, the method further includes providing, for user selection, at least one alterable feature to alter the example object to become the product for purchase by the user. In at least some embodiments, the at least one alterable feature includes at least one of color, decoration, pattern, size, material, shape, or type of product. In at least some embodiments, the method further includes delivering a portion of the payment to an owner of the database or a supplier of the code or marking.

A further embodiment is a non-transitory computer-readable medium having processor-executable instructions for identifying an object or product for purchase, the processor-executable instructions when installed onto a device enable the device to perform actions, the actions including: scanning, at a user request, an example object for a code or marking; reading the code or marking; communicating with a database to index the code or marking with information about the example object, wherein the information includes contact information or a contact link for a manufacturer or supplier of the example object; and receiving the information and providing the information to a user.

In at least some embodiments, the actions further include sending an order for a product using the contact information or contact link for the manufacturer or supplier. In at least some embodiments, the actions further include providing, for user selection, at least one alterable feature to alter the example object to become a product for purchase by the user.

Yet another embodiment is a non-transitory computer-readable medium having processor-executable instructions for purchasing a product, the processor-executable instructions when installed onto a device enable the device to perform actions, the actions including: receiving a code or marking scanned from an example object; communicating with a database to index the code or marking with information about the example object; providing the information to the user including an opportunity or a link for purchase of the object; receiving an order for the object; receiving payment for the order; and delivering a portion of the payment to an entity that displayed the example object from which the code or marking was scanned.

In at least some embodiments, the actions further include providing, for user selection, at least one alterable feature to alter the example object to become the product for purchase by the user.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a schematic block diagram of one embodiment of a system for identifying objects or products for purchase, according to the invention;

FIG. 1B is a schematic diagram of an environment for practicing the invention, according to the invention;

FIG. 2 is a schematic flowchart of one embodiment of a method for identifying an object or product for purchase, according to the invention; and

FIG. 3 is a schematic flowchart of one embodiment of a method for purchasing a product, according to the invention.

### DETAILED DESCRIPTION

The present invention is directed to the area of displaying objects and facilitating sales of the objects. The present invention is also directed to methods and systems for displaying objects and facilitating sales of the personalized variations of those objects.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of processor and any suitable type of device that includes a processor.

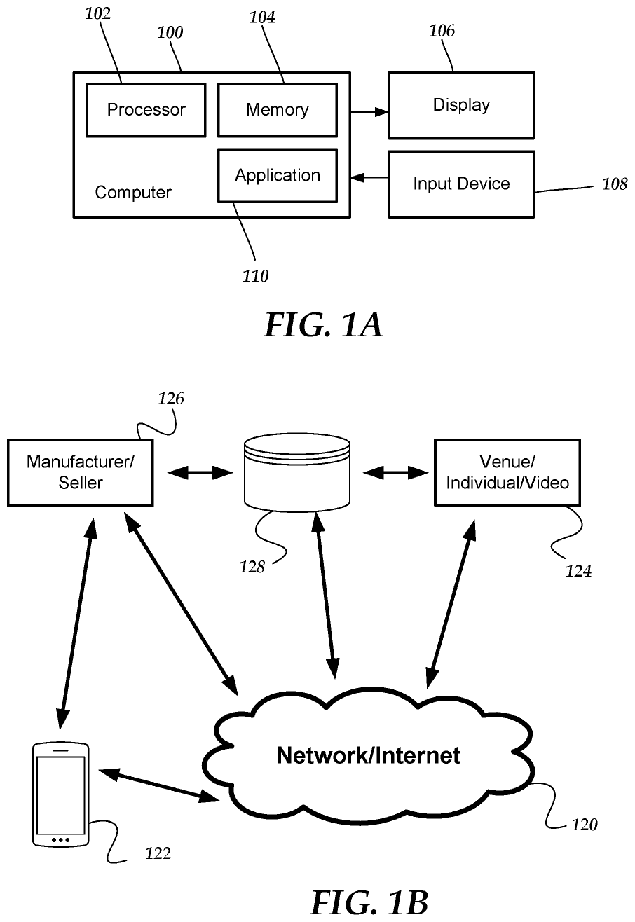

FIG. 1A illustrates one embodiment of a system for practicing the invention. The system can include a computer 100 or any other device that includes a processor 102 and a memory 104, a display 106, an input device 108, and an application as described in more detail below.

The computer 100 can be a mobile device, smartphone, tablet, laptop computer, desktop computer, or other device that can run applications or programs, or any other suitable device for processing information and for presenting a user interface. The computer 100 can utilize any suitable processor 102 including one or more hardware processors that may be local to the user or non-local to the user or other components of the computer. The processor 102 is configured to execute instructions provided to the processor, as described below.

Any suitable memory 104 can be used for the computer 100. The memory 104 illustrates a type of computer-readable media, namely computer-readable storage media. Computer-readable storage media may include, but is not limited to, nonvolatile, non-transitory, removable, and non-removable media implemented in any method or technology for storage of information, such as computer readable instructions, data structures, program modules, or other data. Examples of computer-readable storage media include RAM, ROM, EEPROM, flash memory, or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computer.

Communication methods provide another type of computer readable media; namely communication media. Communication media typically embodies computer-readable instructions, data structures, program modules, or other data in a modulated data signal such as a carrier wave, data signal, or other transport mechanism and include any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

The display 106 can be any suitable display device, such as a monitor, screen, display, or the like. The input device 108 can be, for example, a keyboard, mouse, touch screen, track ball, joystick, voice recognition system, or any combination thereof, or the like and can be used by the user to interact with a user interface.

FIG. 1B illustrates one embodiment of an environment which includes a network (such as the Internet or any other local, private, or wide-area network or any combination thereof), a user's device 122 (such as computer 100 of FIG. 1A), a venue/individual/video 124 that displays an object, a manufacturer or seller of the object, and a database 128 of information about the objects, as described in more detail below. Examples of connections between the elements are illustrated in FIG. 1B, but there may be more or fewer connections in any particular embodiment.

As indicated above, consumers can be inspired to buy products from their experiences in the real world. For example, when staying at a boutique hotel, a consumer is surrounded by curated items (for example, lamps, wallpaper, flooring, ceramics, tiles, carpets, drapes, decorative objects, or the like). Similarly, other physical venues such as restaurants, private houses, and boutique shops can include such items. Inspiration for a purchase may also come from another person who may be wearing something the consumer likes or has home decorations or objects that the consumer desires. Inspiration may also come from videos viewed by the consumer. Moreover, the inspiration may not be the item itself, but rather a characteristic of the item, such as the material, design, or shape (for example, the cut, pattern, or material of a dress or other clothing article or the shape of a metal or plastic object, such as a 3D printed object.)

All of these physical locations and circumstances are potential shop windows for mass personalized goods to inspire a consumer to purchase a personalized product. The physical world remains a great place to find inspiration. However, it may be challenging to recreate the look of a boutique hotel. For example, a lamp may be displayed in the hotel and a consumer may be interested in obtaining a similar lamp. The consumer could look for a label, but the label may have been removed. The consumer might ask the staff, but the staff likely wouldn't know where the lamp was purchased.

As described herein, a software application 110 (FIG. 1A) (for example, on a mobile device such as computer 100 of FIG. 1A or user device 122 of FIG. 1B) may be used to identify an object (also referred to herein as an “example object”) and the manufacturer or seller of the object. For example, the application may identify the object from a photo, video, or live viewing of the item. In at least some embodiments, the object may have a visible or non-intrusive code or marking that the application can scan to identify the object. The software application can read the code or marking (for example, using a camera of a mobile device to scan the code or marking) and provide a link, website, other product/contact information, or the like that describes the object or links the user to a manufacturer or seller of the object. In at least some embodiments, the device may retain the marking, code, link, website, or the like for later reference or use.

In at least some embodiments, the code or marking can be printed on the object or incorporated into the decoration of the object. For example, the code or marking could be incorporated in the pattern of a carpet, decoration, drapery, clothing, textile, or the like. In at least some embodiments, the code or marking is not visible to the user or is unobtrusive. In at least some embodiments, the code or marking can be provided near the object, such as on a label or tag or the like. The code or marking can be encoded using, for example, a Digimarc™ code or the like, a QR code, a barcode, or the like or the code could be provided on a label (or could just be the label itself with the application reading the label.)

As an example, a user could point their mobile phone at an object, scan the code or marking on or near the object, and receive a link that, when followed, describes the object, and lists the manufacturer or one or more sellers of the object. The user may scan multiple codes or markings in a hotel room and later, when at home, review the links, websites, or the like associated with the codes or markings and decide whether to purchase one or more of the objects or products similar to the object. Examples of objects include, but are not limited to, decorative objects, rugs, carpet, paintings or other art works, lamps, light fixtures, draperies, bed coverings, clothing, other textiles, jewelry, watches, or the like.

In at least some embodiments, the user can obtain the object from the same manufacturer or seller as the hotel and the object can be the same quality as the object in the hotel. In at least some embodiments, the manufacturer or seller receives an order from a user that is viewing (or has viewed) the object in a venue (such as a hotel, restaurant, home, or the like) curating and displaying their product and giving inspiration to the user. In at least some embodiments, the manufacturer or seller essentially receives a “repeat” order because the user bust the object, or a product similar to the object, from the same manufacturer or seller instead of searching for a seller that could provide the object.

In at least some embodiments, the hotel or other venue acts as a “shop window” for the manufacturer or seller. In at least some embodiments, a venue or individual could be known for inspiring new trends or mass personalized products. In at least some embodiments, the venue could arrange objects to create a look in their rooms and inspire purchase of those objects. In at least some embodiments, the venue may be recompensed a percentage or amount for sales of products that were purchased based on the display at the venue.

In at least some embodiments, by creating an environment to curate and show products that may inspire a purchase of objects, individuals (such as an “influencer”) may also act like shops. For example, inspiration may come from a curated collection of products shown by a celebrity or influencer. Users who meet or walk around the homes of such individuals may see ideas they would like to recreate. This interaction may be in-person or may be virtual through video. In at least some embodiments, the individual displaying the product is paid a percentage or amount for sales of products that were purchase based on the individual's display of the object.

In at least some embodiments, a user consuming video content, either live or recorded, can search the video for markings or codes. In at least some embodiments, a layer can be added to the video to show the markings or codes in the video. For example, if a viewer of the video content likes an object (for example, clothes, decorations, wallpaper, furnishings, or the like) that the user sees, the user can obtain the code or marking (for example, from a description of the video or using a camera or application to scan the video) and order the product.

In at least some embodiments, the manufacturer or seller may also provide the opportunity to change one or more features of the object allowing the user to personalize the object. For example, the manufacturer or seller may allow the user to change the color, pattern, material, size, decorations, shape, or the like (or any combination thereof) of the object. This can provide for mass customization of the products sold by a manufacturer or seller by allowing the user to change or modify features of the originally viewed object.

For at least some products, mass customization can be realized using digital print and the accelerating move to mass customization would drive new presses and migration away from traditional presses. In at least some embodiments, different kinds of décor and textile presses would be required to supply the mass customization market. In at least some embodiments, mass customization could drive ink sales. In at least some embodiments, adding the unique code or marking invisibly into the product could use digital printing technology.

In at least some embodiments, a code or marking (which may be invisible) can be embedded into a digitally printed product. In at least some embodiments, the code or marking is linked to a database that references the manufacturer or seller of the product. In at least some embodiments, the code or marking can be captured on a mobile or other device or in a video stream.

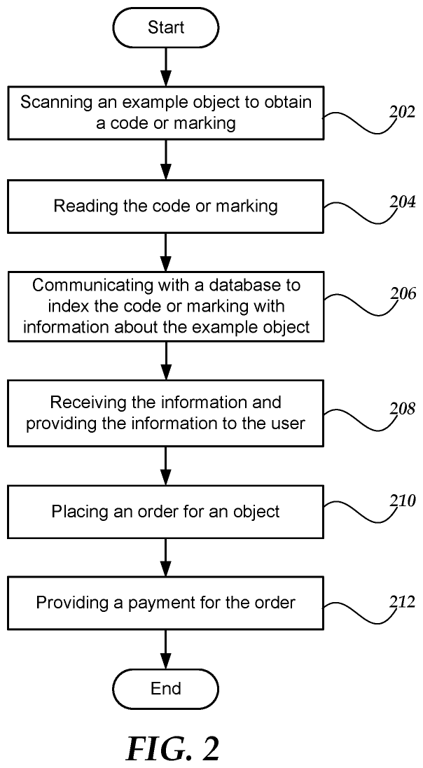

FIG. 2 is a flowchart of one embodiment of a method for purchasing items viewed by the user. In step 202, using a software application 100 (FIG. 1A), the user scans an example object that the user is viewing to obtain a code or a marking. The viewing could take place in a venue, with or on an individual, in a video, or the like. The code or marking may be disposed on the example object or disposed near the example object. The software application can run on a mobile device (e.g., a smart phone or tablet), computer, television, video player, or any other suitable device (such as computer 100 of FIG. 1A or user's device 122 of FIG. 1B). The code or marking can be encoded using, for example, a Digimarc™ code or the like, a QR code, a barcode, or the like or the code could be provided on a label (or could just be the label itself with the application reading the label.)

In step 204, the software application 100 (FIG. 1A) reads the code or marking. In at least some embodiments, the software application stores the code or marking for later viewing or use by the user.

In step 206, the software application 100 (FIG. 1A) communicates with a database 128 (FIG. 1B) to index the code or marking with information about the example object. In at least some embodiments, the software application 100 on the user's device 122 communicates with the database 128 over a network 120 (including, but not limited to, the Internet).

In step 208, the software application 100 (FIG. 1A) receives the information and provides the information to the user. The information includes, but is not limited to, at least one manufacturer or seller of the example object, as well as contact information (for example, a website) or a contact link to the manufacturer or seller. In at least some embodiments, the information may also include the price of the example object, one or more options for modifying the example object, suggestions for products that are similar to the example object, suggestions for products that are made/sold by the same manufacturer or seller, suggestions for products that could be complementary with the example object (for example, similar or complementary decorations, patterns, or the like), or the like or any combination thereof.

In step 210, the user places an order for a product, similar to, or the same as, the example object, using the software application. In at least some embodiments, the user can select from a one or more options to modify or personalize the example object to arrive at the product for which the user places the order. Examples of modifications include changes in color, decoration, pattern, size, material, shape (for example, the shape of metal or plastic object, such as a 3D printed object), type of product (for example, a dress instead of a skirt), or the like or any combination thereof.

In step 212, the user provides payment for the order. In at least some embodiments, the payment is provided after the manufacturer or seller confirms that the product is available for order, in stock, or available for preorder.

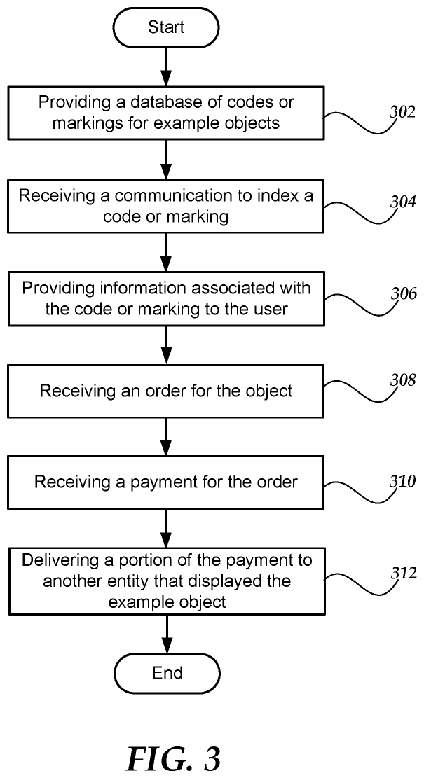

FIG. 3 is a flowchart for a method for providing purchasing opportunities for a viewer of an example object. In step 302, a database of codes or markings is provided for a set of example objects. Each of the example objects includes the code or marking or the code or marking is provided near the example object (for example, on a tag or label). The database indexes the codes or markings with information about the example object, such as a manufacturer or seller of the example object, a website or contact link for the manufacturer or seller, the price of the example object, one or more options for modifying the example object, suggestions for products that are similar to the example object, suggestions for products that are made/sold by the same manufacturer or seller, suggestions for products that could be complementary with the example object (for example, similar or complementary decorations, patterns, or the like), or the like or any combination thereof. The code or marking would be encoded using, for example, a Digimarc™ code or the like, a QR code, a barcode, or the like or the code could be provided on a label (or could just be the label itself with the application reading the label.)

In at least some embodiments, a database of the example objects registered by a supplier of the codes or markings is owned by that supplier (which could be the manufacturer, seller, or a third party). In at least some embodiments, each time the code or marking is used to order a product then the supplier of the code or marking or owner of the database receives a percentage of, or amount from, the sale (assuming that the supplier of the code or marking (or owner of the database) is different from the manufacturer or seller of the example object.)

In step 304, a communication is received from a viewer of an example object to index a code or marking. In step 306, the information from the database is provided to the viewer of the example object. If the viewer decides to purchase a product based on the example object, then in step 308 an order is received for the product.

In step 310, payment is received for the product. In step 312, a portion of the payment may be provided to the venue or individual that displayed the example object. In at least some embodiments, a portion of the payment may also be provided to the owner of the database or the supplier of the code or marking.

The methods and systems described herein may be embodied in many different forms and should not be construed as limited to the embodiments set forth herein. Accordingly, the methods and systems described herein may take the form of an entirely hardware embodiment, an entirely software embodiment or an embodiment combining software and hardware aspects. Systems referenced herein typically include memory and typically include methods for communication with other devices including mobile devices. Methods of communication can include both wired and wireless (e.g., RF, optical, or infrared) communications methods and such methods provide another type of computer readable media; namely communication media. Wired communication can include communication over a twisted pair, coaxial cable, fiber optics, wave guides, or the like, or any combination thereof. Wireless communication can include RF, infrared, acoustic, near field communication, Bluetooth™, or the like, or any combination thereof.

It will be understood that each block of the flowchart illustrations, and combinations of blocks in the flowchart illustrations and methods disclosed herein, can be implemented by computer program instructions. These program instructions may be provided to a processor to produce a machine, such that the instructions, which execute on the processor, create means for implementing the actions specified in the flowchart block or blocks disclosed herein. The computer program instructions may be executed by a processor to cause a series of operational steps to be performed by the processor to produce a computer implemented process. The computer program instructions may also cause at least some of the operational steps to be performed in parallel. Moreover, some of the steps may also be performed across more than one processor, such as might arise in a multi-processor computer system. In addition, one or more processes may also be performed concurrently with other processes, or even in a different sequence than illustrated without departing from the scope or spirit of the invention.

The computer program instructions can be stored on any suitable computer-readable medium including, but not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computer.

The above specification provides a description of the manufacture and use of the invention. Since many embodiments of the invention can be made without departing from the spirit and scope of the invention, the invention also resides in the claims hereinafter appended.

What is claimed as new and desired to be protected by Letters Patent of the United States is:

1. A method for identifying an object or product for purchase, the method comprising:
scanning, by the user, an example object for a code or marking;
reading the code or marking;
communicating with a database to index the code or marking with information about the example object, wherein the information comprises contact information or a contact link for a manufacturer or supplier of the example object; and
receiving the information and providing the information to the user.

2. The method of claim 1, further comprising sending an order for a product using the contact information or contact link for the manufacturer or supplier.

3. The method of claim 1, wherein the information includes at least one alterable feature to alter the example object to become a product for purchase by the user.

4. The method of claim 1, further comprising providing, for user selection, at least one alterable feature to alter the example object for a product for purchase by the user.

5. The method of claim 4, wherein the at least one alterable feature comprises at least one of color, decoration, pattern, size, material, shape, or type of product.

6. The method of claim 1, wherein the scanning comprises scanning the example object in situ.

7. The method of claim 1, wherein the scanning comprises scanning the example object displayed in a video presentation.

8. The method of claim 1, wherein the code or marking is not visible to the user.

9. The method of claim 1, wherein the code or marking is incorporated in a decoration or pattern presented on the example object.

10. The method of claim 1, wherein the code or marking is incorporated on a label attached to, or near, the example object.

11. A method for purchasing a product, the method comprising:
providing a database of codes or markings that are scanned from example objects, wherein the database includes information about the example objects including, for each example object, a manufacturer or supplier of the example object and either contact information or a contact link for the manufacturer or supplier;
receiving, from requester, a communication to index a code or marking;
providing the information to the requester;
receiving an order for a product using the contact information or contact link for the manufacturer or supplier;
receiving payment for the order; and
delivering a portion of the payment to an entity that displayed the example object from which the code or marking was scanned.

12. The method of claim 11, wherein the information includes at least one alterable feature to alter the example object for a product for purchase by the user.

13. The method of claim 11, further comprising providing, for user selection, at least one alterable feature to alter the example object to become the product for purchase by the user.

14. The method of claim 13, wherein the at least one alterable feature comprises at least one of color, decoration, pattern, size, material, shape, or type of product.

15. The method of claim 11, further comprising delivering a portion of the payment to an owner of the database or a supplier of the code or marking.

16. A non-transitory computer-readable medium having processor-executable instructions for identifying an object or product for purchase, the processor-executable instructions when installed onto a device enable the device to perform actions, the actions comprising:
scanning, at a user request, an example object for a code or marking;
reading the code or marking;
communicating with a database to index the code or marking with information about the example object, wherein the information comprises contact information or a contact link for a manufacturer or supplier of the example object; and
receiving the information and providing the information to a user.

17. The non-transitory computer-readable medium of claim 16, wherein the actions further comprise sending an order for a product using the contact information or contact link for the manufacturer or supplier.

18. The non-transitory computer-readable medium of claim 16, wherein the actions further comprise providing, for user selection, at least one alterable feature to alter the example object to become a product for purchase by the user.

19. A non-transitory computer-readable medium having processor-executable instructions for purchasing a product, the processor-executable instructions when installed onto a device enable the device to perform actions, the actions comprising:
receiving a code or marking scanned from an example object;
communicating with a database to index the code or marking with information about the example object;
providing the information to the user including an opportunity or a link for purchase of the object;
receiving an order for the object;
receiving payment for the order; and
delivering a portion of the payment to an entity that displayed the example object from which the code or marking was scanned.

20. The non-transitory computer-readable medium of claim 19, wherein the actions further comprise providing, for user selection, at least one alterable feature to alter the example object to become the product for purchase by the user.
